(19) United States
(12) Patent Application Publication
(10) Pub. No.: US 2018/0045102 A1
(43) Pub. Date: Feb. 15, 2018

(54) CHARGE AIR COOLER FOR A MOTOR VEHICLE

(71) Applicant: Mahle International GmbH, Stuttgart (DE)

(72) Inventors: Christian Buerck, Boeblingen (DE); Stefan Dieterle, Esslingen (DE); Alexander Ehmke, Detmold (DE); Guenther Feuerecker, Stuttgart (DE); Eberhard Pantow, Winnenden (DE); Thomas Strauss, Notzingen (DE); Holger Striege, Moeglingen (DE)

(21) Appl. No.: 15/673,375

(22) Filed: Aug. 9, 2017

(30) Foreign Application Priority Data
Aug. 10, 2016 (DE) 10 2016 214 886.9

(51) Int. Cl. F02B 29/04

(52) U.S. Cl. CPC F02B 29/0468

(57) ABSTRACT

A charge air cooler for an internal combustion engine may include a heat exchanger having a plurality of fluid paths through which charge air to be cooled is flowable. The charge air cooler may also include a collector attached to the heat exchanger and communicating with the fluid paths. A lower region of the collector may be configured as a condensate receiving zone for receiving condensed charge air. At least one pipe body may be arranged in the collector and may delimit a fluid channel through which condensed and non-condensed charge air may be flowable. An opening may be formed in the at least one pipe body and may fluidically connect the fluid channel to the condensate receiving zone.

### CROSS-REFERENCE TO RELATED APPLICATIONS

This application claims priority to German Patent Application No. DE 10 2016 214 886.8, filed on Aug. 10, 2016, the contents of which are incorporated herein by reference.

### TECHNICAL FIELD

The present invention relates to a charge air cooler, in particular for a motor vehicle, in particular for an internal combustion engine as well as an internal combustion engine with such a charge air cooler.

### BACKGROUND

Known from DE 10 2009 042 981 A1 is a generic charge air cooler having an air inlet box and an air outlet box as well as a condensate collector for collecting condensate separated in the charge air cooler. Furthermore, a condensate line is provided which is connected via an inlet to the condensate collector and via an outlet to an intake line of an internal combustion engine. During operation of the charge air cooler this is intended to bring about extraction of condensate from the condensate collector due to differential pressure, with the result that hitherto used actuators, valves and/or controllers can be omitted.

Known from DE 10 2009 011 634 A1 is a charge air cooler comprising a hose element which connects the charge air cooler to an intake manifold.

### SUMMARY

The present invention is concerned with the problem of providing an improved or at least alternative embodiment for a charge air cooler of the generic type, which is in particular characterized by an improved removal of charge air from the charge air cooler.

This object is solved by the subject matter of the independent patent claims. Preferred embodiments are the subject matter of the dependent claims.

The basic idea of the invention is accordingly to provide a condensate receiving zone for receiving condensate precipitated from the charge air in a collector of the charge air cooler in which the charge air is collected after flowing through the heat exchanger. Such a collector is also known to the person skilled in the art as “air collecting box” or “collecting box”.

Since the charge air in the heat exchanger is cooled by dissipating heat to a coolant, condensation of parts of the charge air typically takes place during flow through the heat exchanger or directly at the exit from the heat exchanger, i.e. at the inlet into the collector arranged downstream of the heat exchanger.

The formation of a condensate receiving zone in said collector has the effect on the one hand that the condensate is collected specifically at the place where it is precipitated, i.e. formed; on the other hand no additional installation space is required for the condensate receiving zone since this is integrated in the collector arranged downstream of the heat exchanger.

The invention is further based on the idea to provide a pipe body in the collector which delimits a fluid channel through which both condensate and charge air can flow. In this case, an opening is formed in the pipe body which fluidically connects the fluid channel to the condensate receiving zone. The opening is preferably located at the lowest point of the pipe body which can particularly expediently be formed as a U-shaped pipe body.

In this way, the charge air flowing through the pipe body can be used to, as it were, “entrain” the condensate collected in the condensate receiving zone and remove it from the condensate receiving zone. This is possible even when there is only a small pressure difference of the charge air pressure between the collector and an intake manifold typically located downstream of the charge air cooler. As a result, in a charge air cooler according to the invention, the precipitated condensate can therefore be specifically collected in a condensate receiving zone of the collector and also effectively removed from this again without a technically complex construction being necessary for this.

A charge air cooler according to the invention for an internal combustion engine comprises a heat exchanger, which has a plurality of a fluid paths through which charge air to be cooled can flow. A collector is attached to the heat exchanger which communicates with the fluid paths. A lower region of the collector is configured as a condensate receiving zone for receiving precipitated condensate of the charge air. At least one pipe body is arranged in the collector which delimits a fluid channel through which both condensate and also charge air can flow. An opening is in turn provided in the at least one pipe body which fluidically connects the fluid channel to the condensate receiving zone

In a preferred embodiment, the pipe body has a pipe body inlet and a pipe body outlet, which in a usage position of the charge air cooler, in particular in the engine compartment of a motor vehicle are both located above the opening. This allows an effective introduction of charge air into the pipe body.

Particularly preferably the opening is arranged in the condensate receiving zone whereas the pipe body inlet as well as the pipe body outlet are arranged outside the condensate receiving zone. In this way it is ensured that only charge air is introduced via the pipe body inlet into the pipe body and that only condensate passes through the opening into the pipe body and is there entrained by the charge air and that charge air and condensate together can emerge from the pipe body again and can leave the collector.

In a further preferred embodiment, the pipe body has a U-shaped geometry at least in sections. Such a geometry makes it easy to implement the aforesaid arrangement of pipe body inlet and outlet above the opening.

Expediently, the U-shaped pipe body at least in sections has a base section which at its opposite ends, preferably integrally, goes over into a first and a second leg section. In this variant, the opening is arranged in the base section. The pipe body inlet is arranged in the first leg section and the pipe body outlet is arranged in the second leg section.

In a further preferred embodiment, the second leg section facing away from the heat exchanger comprises an outlet section. Said outlet section extends away from the base section parallel to the fluid lines of the heat exchanger. In this case the pipe body outlet of the pipe body is arranged in the outlet section. By means of the outlet section it can be ensured that the condensate lead out from the pipe body cannot go back into the condensate receiving zone.

In an advantageous further development, the collector comprises a housing which delimits a housing interior. In a further development the condensate receiving zone is part of the housing interior and is delimited by a trough-shaped housing base which is in turn part of the housing. This variant is associated with particularly low production costs.

Particularly preferably the opening is arranged in a region of the base section which has a minimal distance from the housing base which delimits the condensate receiving zone. In this way it is ensured that even when a small quantity of condensate is collected in the condensate receiving zone, this cannot enter into the pipe body via the opening.

Alternatively or additionally, the opening can face the housing base. This measure also ensures that even when only a small quantity of condensate is collected in the condensate receiving zone, this cannot enter into the pipe body via the opening.

Particularly preferably the pipe body inlet is facing away from the housing base. This allows an effective introduction of non-condensed charge air emerging from the heat exchanger into the pipe body.

Particularly expediently, the fluid paths present in the heat exchanger open into the collector via respective fluid path outlet openings. In this variant the pipe body outlet is oriented parallel to the fluid path outlet openings. This allows an effective removal of condensate from the collector after exit from the pipe body and specifically with the aid of the charge air flowing outside the pipe body through the collector.

In an advantageous further development, the pipe body inlet, the opening and the pipe body outlet are each oriented turned through 90° with respect to one another.

A particularly flexible assembly and disassembly of the pipe body at the collector is allowed by a further preferred embodiment in which the housing of the collector and the pipe body are formed in two parts. In this variant, the pipe body is fastened detachably to the housing which can preferably be achieved with the aid of preferably a clip or latch connection.

A further preferred embodiment in which the pipe body is formed integrally on the housing of the collector is however associated with particularly low manufacturing costs.

In a further preferred embodiment, at least two pipe bodies having a respective opening are stacked one upon the other or arranged one above the other in the collector. The at least two pipe bodies can be arranged at a distance from one another or abut against one another. In this variant, the at least two provided openings are arranged at a distance from one another and at a different distance from the condensate collecting zone in the collector. If the liquid level from the condensate in the lowest pipe body is so high that the pressure of the liquid column above the opening is higher than the available pressure drop between inlet and outlet of the pipe, the lowest pipe body is then blocked and cannot convey any more liquid. In the embodiment proposed here, the removal of the condensate can be maintained by at least one pipe body arranged higher, which does not convey any liquid when the liquid level is low since it does not dip into the condensate. In this way, the desired effect of the pipe body can be ensured even when the liquid level fluctuates substantially, for example, due to condensate accumulating in gushes.

The invention further relates to an internal combustion engine comprising an exhaust gas system and a charge air cooler presented hereinbefore. The previously explained advantages of the charge air cooler according to the invention are therefore also transferred to the internal combustion engine.

Further important features and advantages of the invention are obtained from the subclaims, from the drawings and from the relevant description of the figures with reference to the drawings.

It is understood that the features mentioned previously and to be explained further hereinafter can be used not only in the respectively given combination but also in other combinations or alone without departing from the scope of the present invention.

Preferred exemplary embodiments of the invention are presented in the drawing and are explained in detail in the following description.

### BRIEF DESCRIPTION OF THE DRAWINGS

The FIGURE illustrates in schematic highly simplified view the structure of a charge air cooler.

### DETAILED DESCRIPTION OF THE DRAWINGS

The single FIGURE illustrates in schematic highly simplified view the structure of a charge air cooler 1 according to the invention for cooling the charge air to be introduced into the combustion chambers of an internal combustion engine. The charge air cooler 1 comprises a heat exchanger 2 which has a plurality of fluid paths 3 for the charge air 5 to be cooled to flow through. The fluid paths 3 are therefore part of the heat exchanger 2. The heat exchanger 2 can be formed in the manner of a stacked plate heat exchanger through which charge air 5 flows and, fluidically separately from this, a coolant (not shown). For this purpose, the fluid paths 3 through which the charge air can flow alternate along a stacking direction with coolant paths 7 through which coolant can flow. As a result of thermal interaction of the charge air 5 with the coolant, the charge air 5 is cooled so that after flowing through the charge air cooler 1 it can be introduced again with reduced temperature into the combustion chambers of the internal combustion engine. When the charge air cooler 1 is used in a motor vehicle, the ambient air of the motor vehicle can be used as coolant, by introducing this as turbulence into the charge air cooler 1 and removing this again.

Alternatively to the stacked plate heat exchanger, a tube bundle heat exchanger 22 can also be used as heat exchanger 2. Technically, the tube bundle heat exchanger 22 can be formed by a hollow cylinder 25 of a suitable material, typically of a metal, in the interior 26 of which a plurality of pipe bodies 23 are located. Alternatively to the geometry of a hollow cylinder 25, other suitable geometries are also feasible. Said pipe bodies 23 form the fluid paths 3 through which charge air can flow. The part of the interior 26 complementary to these pipe bodies 23 forms one or more coolant paths 7 for the coolant to flow through. The pipe bodies 23 can be fixed on an end plate 24 of the heat exchanger 2.

The more precise design structure of the heat exchanger 2 or tube bundle heat exchanger 22 is not the essence of the invention presented here and is familiar to the person skilled in the art so that at this point more detailed explanations are dispensed with. Relevant for the present invention however is a collector 9 attached to the heat exchanger 2 and communicating with the fluid paths 3, which communicates fluidically with the fluid paths 3. In this way, after flowing through the individual fluid paths 3, the charge air 5 is collected and introduced into the combustion chambers of the internal combustion engine. The collector 9 comprises a housing 16 which delimits a housing interior 19. A lower part of the housing 16 is formed by a housing base 17 which can be formed integrally on the housing 16.

In the course of the cooling of the charge air 5 in the heat exchanger 2, a part of the gaseous charge air can condense out and precipitate as condensate 6 in the charge air cooler 1. For this purpose the charge air cooler 1 has a condensate receiving zone 4 for this condensate 6. As confirmed clearly in the FIGURE, the condensate receiving zone 4 is configured to receive the condensed charge air 5 through a lower region 7 of the collector 9. Thus, no additional installation space on the charge air cooler 1 must be provided for the condensate receiving zone 4. The condensate receiving zone 4 is delimited by the housing base 17 of the housing 16 of the collector 9 and is configured to be trough-shaped in the example scenario.

For removal of the condensate 6 collected in the condensate receiving zone 4 from the collector 9, a pipe body 8 is provided in the housing interior 19 which delimits a fluid channel 18. An opening 10 is provided in the pipe body 8 which fluidically connects the fluid channel 18 to the condensate receiving zone 4. The opening 10 is located inside the condensate receiving zone 4 in the pipe body 8. Through the opening 10 the condensate 6 can pass from the condensate receiving zone 4 into the pipe body 8.

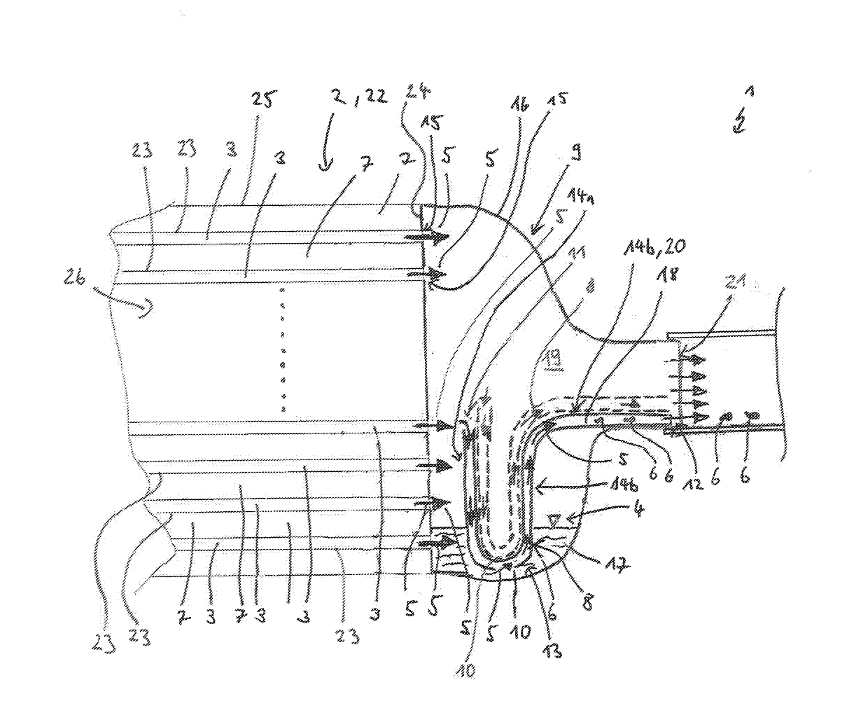

The pipe body 8 further comprises a pipe body inlet 11 and a pipe body outlet 12 which in a usage position of the charge air cooler 1 are both located above the opening 10. The pipe body inlet 11 and the pipe body outlet 12 are both arranged outside the condensate receiving zone 4. Thus, non-condensed charge air 5 emerging from the heat exchanger 2 can enter into the pipe body, flow through the pipe body 8 and emerge from this again. The condensate present in the condensate receiving zone 4 is entrained by the charge air 5 flowing through the pipe body 8, as indicated in FIG. 1, and in this way removed from the condensate receiving zone 4 and therefore also from the collector 9. The condensate 6 can in this case by “entrained” as liquid film, as foam or in the form of droplets by the charge air.

After leaving the pipe body 8 through the pipe body outlet 12, charge air 5 and condensate 6 together with the charge air not guided through the pipe body 8 can be removed from the collector 9 through a collector outlet 21 provided in the housing 16 of the collector 9. The pipe body 8 can be made of a metal or a plastic and can be fastened by means of a detachable connection (not shown in the FIGURE), for example by means of a clip or latch connection, on the housing 16. The pipe body 8 can be implemented with an inside diameter of 8 mm to 10 mm. Alternatively to this, however a one-part design is also feasible in which the pipe body 8 is formed integrally of plastic on the housing 16 made of plastic.

In the example scenario, usage position is understood as the installation orientation of the charge air cooler 1 in the engine compartment of a motor vehicle.

As can be seen from the FIGURE, the pipe body 8 has a U-shaped geometry in sections. The pipe body 8 which is U-shaped in sections comprises a base section 13 which goes over at its opposite ends into a first and a second leg section 14a, 14b. The opening 10 is arranged in the base section 13. The opening 10 can be implemented as a through hole which has a diameter between 1 mm and 2 mm. The pipe body inlet 11 is arranged in the first leg section 14a and the pipe body outlet 12 is arranged in the second leg section 14b. The second leg section 14b facing away from the heat exchanger 2 comprises an outlet section 20 which extends away from the base section parallel to the fluid lines 3 of the heat exchanger. The pipe body outlet 12 is arranged in the outlet section 20. The pipe body inlet 11 is facing away from the housing base 17.

As the FIGURE additionally illustrates, the opening 10 is arranged in a region of the base section 13 of the U-shaped pipe body 8 having a minimal distance from the housing base 17 of the housing 16. The opening 10 is facing the housing base 17 in this case.

The guide paths 3 provided in the heat exchanger 2 open into the collector 9 via respective fluid path outlet openings 15. The pipe body outlet 12 is oriented parallel to the fluid path outlet openings 15. In the example scenario, the pipe body inlet 11, the opening 10 and the pipe body outlet 12 are each oriented turned through 90° with respect to one another.

The housing 16 of the collector 9 and the pipe body 8 can be configured as two-part. In this variant the pipe body can be detachably fastened on the housing 16 by means of a clip or latch connection (not shown in the FIGURE). Alternatively to this, however, the pipe body 8 can however also be formed integrally on the housing 16 of the collector 9.

In a further development, not only a single pipe body 8 is arranged in the collector 9 but at least two pipe bodies 8 having a respective opening 10 are stacked on top of one another. In this variant, the at least two provided openings 10—each pipe body 8 is provided with an opening 10—are arranged at a distance from one another and with different distances to the condensate receiving zone 4 or to the housing base 17 in the collector 9. If the liquid level from the condensate 6 in the lowest pipe body 8, i.e. nearest to the condensate receiving zone 4 or the housing base 17 is so high that the pressure of the liquid column of the condensate 6 above the opening 10 is greater than the available pressure drop between pipe body inlet 11 and pipe body outlet 13 of the pipe body 8, the lowest pipe body 8s is blocked and cannot convey any condensate 6. In the further development with at least two pipe bodies 8 on the other hand, the removal of the condensate 6 through at least one higher pipe body 8 can be maintained which at low liquid level conveys no liquid since it does not dip into the condensate 6. Another pipe body 8 is indicated in dashed representation in FIG. 1. It is clear that three or more pipe bodies 8 can be stacked on one another in the collector 9 which is not shown in the FIGURE for the sake of clarity. In this way, the desired effect of the pipe body 8 can be ensured even when the liquid level fluctuates substantially, for example, due to condensate accumulating in gushes.

1. A charge air cooler for an internal combustion engine, comprising:
a heat exchanger having a plurality of fluid paths through which charge air to be cooled is flowable;
a collector attached to the heat exchanger and communicating with the fluid paths;
wherein a lower region of the collector is configured as a condensate receiving zone for receiving condensed charge air;
wherein at least one pipe body is arranged in the collector and delimits a fluid channel through which condensed and non-condensed charge air is flowable; and
wherein an opening is formed in the at least one pipe body and fluidically connects the fluid channel to the condensate receiving zone.

2. The charge air cooler according to claim 1, wherein the at least one pipe body has a pipe body inlet and a pipe body outlet, which in a usage position of the charge air cooler are both located above the opening.

3. The charge air cooler according to claim 1, wherein the opening is arranged in the condensate receiving zone, and the pipe body inlet and the pipe body outlet are arranged outside the condensate receiving zone.

4. The charge air cooler according to claim 1, wherein the at least one pipe body has a U-shaped geometry at least in sections of the at least one pipe body.

5. The charge air cooler according to claim 4, wherein:
the at least one pipe body having the U-shaped geometry has a base section, which at its opposite ends transitions into a first leg section and a second leg section; and
the opening is arranged in the base section, the pipe body inlet is arranged in the first leg section, and the pipe body outlet is arranged in the second leg section.

6. The charge air cooler according to claim 5, wherein the second leg section facing away from the heat exchanger includes an outlet section extending away from the base section parallel to the fluid paths of the heat exchanger, the pipe body outlet being provided in the outlet section.

7. The charge air cooler according to claim 1, wherein:
the collector includes a housing delimiting a housing interior; and
the condensate receiving zone is part of the housing interior and is delimited by a trough-shaped housing base that is part of the housing.

8. The charge air cooler according to claim 7, wherein the opening is arranged in a region of a base section of the at least one pipe body, the opening having a minimal distance from the housing base, which delimits the condensate receiving zone.

9. The charge air cooler according to claim 6, wherein the opening is facing the housing base.

10. The charge air cooler according to claim 5, wherein the pipe body inlet is facing away from the housing base.

11. The charge air cooler according to claim 5, wherein the fluid paths open into the collector via respective fluid path outlet openings and the pipe body outlet is oriented parallel to the fluid path outlet openings.

12. The charge air cooler according to claim 5, wherein the pipe body inlet, the opening, and the pipe body outlet are each oriented turned through 90° with respect to one another.

13. The charge air cooler according to claim 7, wherein the housing of the collector and the at least one pipe body are formed in two parts, and that the pipe body is fastened detachably to the housing via one of a clip and a latch connection.

14. The charge air cooler according to claim 7, wherein the at least one pipe body is formed integrally on the housing of the collector.

15. The charge air cooler according to claim 1, the at least one pipe body includes at least two pipe bodies each having a respective opening and that are stacked one upon the other in the collector so that the openings of the at least two pipe bodies are arranged at a distance from one another and at a different distance from the condensate collecting zone in the collector.

16. An internal combustion engine comprising an exhaust gas system and a charge air cooler:
a heat exchanger having a plurality of fluid paths through which charge air to be cooled is flowable;
a collector attached to the heat exchanger and communicating with the fluid paths;
wherein a lower region of the collector is configured as a condensate receiving zone for receiving condensed charge air;
wherein at least one pipe body is arranged in the collector and delimits a fluid channel through which condensed and non-condensed charge air is flowable; and
wherein an opening is formed in the at least one pipe body and fluidically connects the fluid channel to the condensate receiving zone.

17. A charge air cooler for an internal combustion engine, comprising:
a heat exchanger having a plurality of fluid paths through which charge air to be cooled is flowable;
a collector attached to the heat exchanger and communicating with the fluid paths, the collector having a lower region configured as a condensate receiving zone for receiving condensed charge air;
at least one pipe body arranged in the collector and delimiting a fluid channel through which condensed and non-condensed charge air is flowable, the at least one pipe body having an opening formed therein that fluidically connects the fluid channel to the condensate receiving zone, at least sections of the at least one pipe body being U-shaped, the at least one pipe body having having a base section that transitions into a first leg section and a second leg section at opposite ends of the base section;
wherein the opening is arranged in the base section, the pipe body inlet is arranged in the first leg section, and the pipe body outlet is arranged in the second leg section.

18. The charge air cooler according to claim 17, wherein the second leg section facing away from the heat exchanger includes an outlet section extending away from the base section parallel to the fluid paths of the heat exchanger, the pipe body outlet being provided in the outlet section.

19. The charge air cooler according to claim 18, wherein the opening is facing the housing base.

20. The charge air cooler according to claim 17, wherein the pipe body inlet is facing away from the housing base.
